(19) United States
(12) Patent Application Publication
(10) Pub. No.: US 2011/0257824 A1
(43) Pub. Date: Oct. 20, 2011

(54) CONTROL SYSTEM, A HYBRID CONTROL MODULE, AND METHOD FOR CONTROLLING A HYBRID VEHICLE

(75) Inventors: Brian COUCHENE, Alexandria, OH (US); Daniel FREDRICK, Alexandria, OH (US)

(73) Assignee: ALTERNATIVE MOTIVE POWER SYSTEMS, LLC, Alexandria, OH (US)

(21) Appl. No.: 13/086,297

(22) Filed: Apr. 13, 2011

Related U.S. Application Data
(60) Provisional application No. 61/324,283, filed on Apr. 14, 2010.

(51) Int. Cl. G06F 19/00

(52) U.S. Cl. 701/22; 180/65.245; 903/902

(57) ABSTRACT

A control system, a hybrid control module, and method for controlling a hybrid vehicle are provided. The hybrid control module includes a computer and a plurality of predefined values and steps stored and implemented by the computer in response to a signal from the hybrid control module and input from an operator. Each of the plurality of predefined values and steps controls a component of the hybrid vehicle or controls a plurality of functions within the hybrid control module. The hybrid control module provides conventional vehicle functionality and feel to the hybrid vehicle in response to operator input.

### CROSS-REFERENCE TO RELATED APPLICATIONS

This patent application claims the benefit of U.S. Provisional Patent Application Ser. No. 61/324,283 filed on Apr. 14, 2010, and entitled “Hybrid Control Module,” the disclosure of which is incorporated by reference as if fully rewritten herein.

### BACKGROUND

The present disclosure is directed to vehicle control modules. More specifically, the present disclosure is directed to a master controller module for hybrid vehicles.

In conventional internal combustion vehicles (conventional vehicles) there are several individual controllers for controlling different functionalities in conventional vehicles and those controllers are: Engine Control Module, Transmission Control Module, and Body Control Module. In conventional vehicles the Engine Control Module (ECM) controls engine functions and accepts operator inputs relating to the engine, for example, accelerator position. In conventional vehicles, the Transmission Control Module (TCM) performs shifting functions and takes input from the operator through the gearshift. In conventional vehicles the Body Control Module (BCM) controls the least critical vehicle functions, for example, interior and exterior lights, buzzers, etc. In conventional vehicles, there may also be other electronic controllers that handle functions such as traction control, stability control, and anti-lock braking control.

Hybrid vehicles, as a result of their inherent lack of mechanical parts, i.e., a transmission and gear box, that are present in conventional vehicles, respond differently to operator commands. Often, hybrid vehicles do not behave like conventional vehicles which leads to operator confusion and error in operating the hybrid vehicle.

Due to the limitations of known systems, there is an ongoing need for a control solution that allows a hybrid vehicle to operate like a conventional vehicle, while obtaining as good as or better performance than a conventional vehicle. There is also an ongoing need for a control solution that provides safety features for hybrid vehicle operation, where the safety features override operator input or operator errors.

### SUMMARY

The present embodiments are applicable to hybrid (genset) vehicles that have a low duty cycle with high torque requirements, also known as intermittent duty cycle applications. These hybrid vehicles generally spend one-third of the time accelerating, one-third of the time coating/decelerating, and one-third of the time stopped or stationary. A few examples of intermittent duty cycle application vehicles are city buses, garbage trucks, and terminal trucks at ship yards or airports. These vehicles are “hybrid” vehicles because they contain both a gas (usually diesel) engine and an electric (traction) motor in series.

In the present embodiments, a modified series genset (hybrid) design is provided, see FIG. 1. In addition to the normal hybrid series design, this modified series hybrid design provides a divided system that breaks up the functionality of the components in the system. The modified series hybrid design includes a separate auxiliary power system that is separate and distinct from an electric drive present in a normal hybrid series design. The separate auxiliary power system includes an auxiliary electric drive, an auxiliary motor, a duel pump and an air compressor. The auxiliary electric drive operates the auxiliary motor which operates an air compressor (spring applied brakes) and a duel pump (power steering, 5^{th} wheel). This configuration provides a hybrid vehicle that performs better than conventional technology, and provides additional safety benefits because important safety features (braking, power steering, etc.) are powered directly by the battery, rather than from the electric motor. An additional benefit from the present disclosure is that extra power is available for the rear wheels (for torque) because auxiliary power supply is powered directly by the battery and does not use power from the electric motor to run the auxiliary motor.

In conventional series hybrid designs, the electric motor controls the fifth wheel, power steering, air compressor, and other functions. In the conventional series hybrid design, the power available for use with the rear wheels is reduced.

In the present embodiments, the Hybrid Control Module (HCM) acts as the master controller. The HCM receives and processes operator inputs that would normally go to other controllers (e.g., ECM, TCM, or BCM) in a conventional vehicle. A good example of this is the accelerator pedal and gearshift lever. In a non-hybrid vehicle, the accelerator pedal connects to the ECM and the gearshift lever connects to the TCM. In contrast, in the series hybrid of the present embodiments, both the accelerator pedal and the gearshift go to the HCM. If the hybrid has an internal combustion engine, it would still have an ECM; however, in many embodiments the throttle would be controlled by the HCM instead of the operator. In the present embodiments, the functionality of the BCM is largely the same; however, the HCM provides the signals to trigger cues to implement functions in the BCM, for example, network data that the BCM might normally expect from other modules may be sent to the BCM from the HCM instead of from other modules.

The HCM may control most functions that are not handled by the BCM. It receives the operator inputs, accelerator pedal, brake pedal, gearshift, etc. The HCM may control the amount of torque and direction to command the main fraction motor inverter. The HCM may control auxiliary motors including fans and motors for electro-hydraulic power steering, hydraulic 5^{th} wheel operation, and air compressors for air brakes, horns, air ride seats, etc. The HCM may monitor the main battery pack's state of charge and determine how or when to operate the APU (Auxiliary Power Unit) In one embodiment, the modified series hybrid may be a diesel genset, and the HCM would command the diesel engine to run by sending network commands to the diesel engine's ECM. For example, in another embodiment, the APU may be a hydrogen fuel cell. In the embodiment when the APU is a fuel cell, the hybrid vehicle would not have an ECM, but would have Fuel Cell Power Module (FCPM) controller instead.

### BRIEF DESCRIPTION OF THE DRAWINGS

FIG. 1 is a block diagram of one embodiment of a series hybrid vehicle.

FIGS. 2-9 are block diagrams of embodiments of the logic code of the Hybrid Control Module.

Wherever possible, the same reference numbers will be used throughout the drawings to refer to the same or like parts.

### DETAILED DESCRIPTION

The present embodiments relate generally to vehicle control modules. More specifically, the present disclosure describes a master controller module for hybrid vehicles.

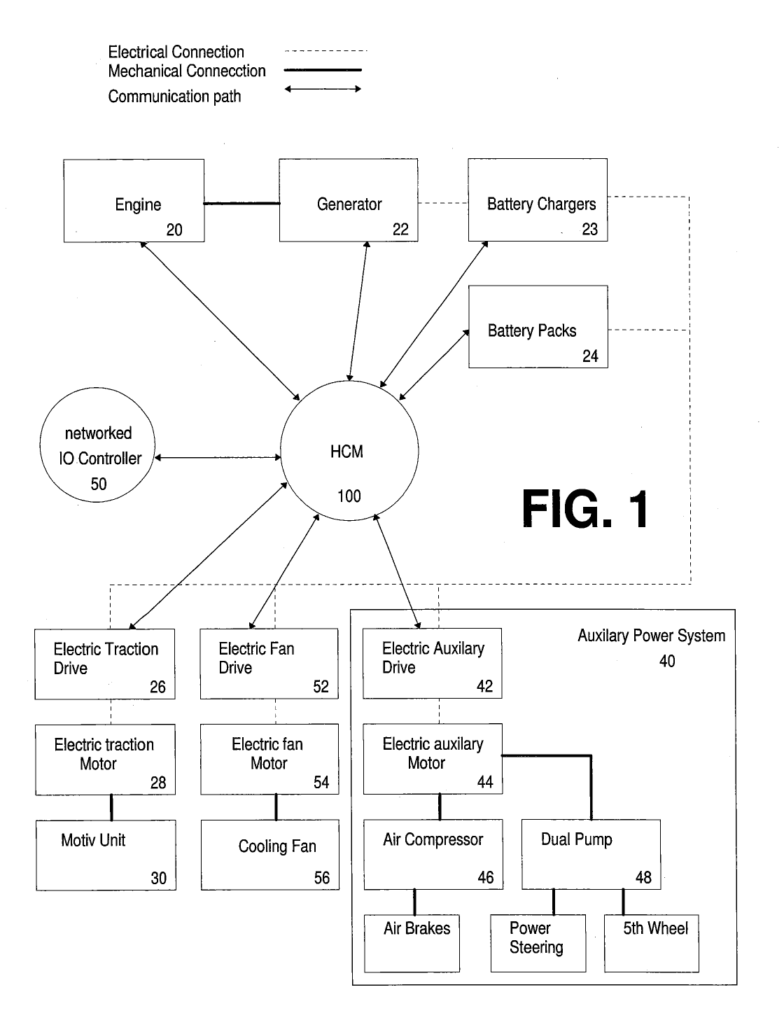

FIG. 1 is a simplified block diagram of a vehicle 10 which in some embodiments may be a series hybrid vehicle. As shown in FIG. 1, mechanical connections are represented by solid lines between components, and electrical connections are represented by dotted lines between components. Lines with arrowheads represent network connections to and from hybrid control module (HCM). Series hybrid vehicles 10 comprise a number of components, for example, an engine 20, a generator 22, battery charges 23, a battery 24, a HCM 100, an electric drive 26, an electric motor 28, rear wheels 30, and an auxiliary power system 40. Engine 20 is mechanically coupled to and drives generator 22. Typically, engine 20 is a diesel engine, but can be any conventional gasoline, natural gas, hydrogen, or other fuel powered engine. Generator 22 is powered by engine 20 and produces electricity. Generator 22 is electrically connected to battery 24 and electric drive 26. The electricity produced by generator 22 charges battery 24. Battery 24 may be a conventional lead-acid battery in some embodiments and may be a rechargeable battery, such as a Ni—Cd battery, or any other battery chemistries in other embodiments. The electricity produced by generator 22 is used to power the electric drive 26. Electric drive 26 is electrically connected to and powers electric motor 28. Electric motor 28 is mechanically connected to motive power unit 30 of vehicle 10, and provides the necessary power and torque to move the vehicle in a forward or reverse direction. A motive unit 30 may be of any variety of structures depending on the particular application. In some embodiments, the electric motor 28 may directly drive each wheel, in which case motive unit 30 my comprise a plurality of wheels and electric motor 28 may comprise a plurality of corresponding electric motors, one per wheel. In other embodiments, corresponding motive unit 30 may be an axle connected to one or more wheels. In some embodiments, motive unit 30 may be a track system, such as may be available on a bulldozer or other vehicle where a track is desirable. While in many embodiments, motive unit 30 may be a rear wheel, in other embodiments, motive unit may be a front wheel. It should be noted that there is no transmission in vehicle 10 and the only gear reduction is built into the drive axle.

Auxiliary power system 40 further includes an auxiliary electric drive 42, an auxiliary motor 44, an air compressor 46, and a dual hydraulic pump 48. Auxiliary power system 40 is electrically connected to and powered by battery 24. Auxiliary power system 40 is electrically connected to auxiliary motor 44. Auxiliary motor 44 is mechanically connected to dual pump 48 and air compressor 46. Auxiliary motor 44 provides the necessary power and torque to operate dual pump 48 and air compressor 46. Dual pump 48 provides power for raising or lowering fifth wheel. Dual pump 48 also provides power to control power steering in the hybrid vehicle. Air compressor 46 produces the necessary air to recharge and supply air to air brakes in the hybrid vehicle. In some embodiments, dual pump 48 may be a hydraulic pump and the system it controls may also be hydraulic. In some embodiments, dual pump 48 may be a pump to control only one item or more than two items.

FIG. 10 provides a block diagram of the DC contactor panel of vehicle 10 of the present disclosure. In the present embodiment, vehicle 10 has two contactor panels, left contactor panel and right contactor panel. The contactors within the panel are in electrical connection with the battery and the inverters, the main traction inverter, the auxiliary inverter and the fan inverter.

Hybrid Control Module (HCM) 100 monitors and controls each of the components in vehicle 10. HCM 100 is the master controller for vehicle 10. HCM 100 receives, interprets, and implements operator input (e.g., pressing on accelerator) from vehicle 10. HCM 100 additionally provides features that override user input to control operating parameters of vehicle 10. Most of inputs from the operator that would go to other controllers go to HCM 100 in vehicle 10. An example of this is the accelerator pedal and gearshift lever. In a conventional engine-only vehicle, the Engine Control Module (ECM) governs use of the accelerator pedal. In a conventional engine-only vehicle, the Transmission Control Module (TCM) governs use of the gearshift lever. In a conventional series hybrid, both the accelerator pedal and the gearshift are controlled by the HCM. If the conventional series hybrid has an internal combustion engine, it would still have an ECM; however, the throttle would be controlled by the HCM instead of the operator.

In one embodiment, HCM 100 hardware is a module manufactured by ifm efector, inc., Exton, Pa., part number CR0032.

HCM 100 controls most functions that are not handled by the BCM. It receives the operator inputs, accelerator pedal, brake pedal, gearshift, etc. It controls the amount of torque and direction to command to the main traction motor inverter. It controls auxiliary motors including fans and motors for electro-hydraulic power steering, hydraulic 5^{th} wheel operation, and air compressors for air brakes, horns, air ride seats, etc. It monitors the main battery pack's state of charge and determines how or when to operate the APU (Auxiliary Power Unit) In one case this could be a diesel genset. It would command the diesel engine to run by sending network commands to the diesel engine's ECM. In some hybrids the APU may be a hydrogen fuel cell. In this hybrid there would not be an ECM, but there would be a FCPM (Fuel Cell Power Module) controller.

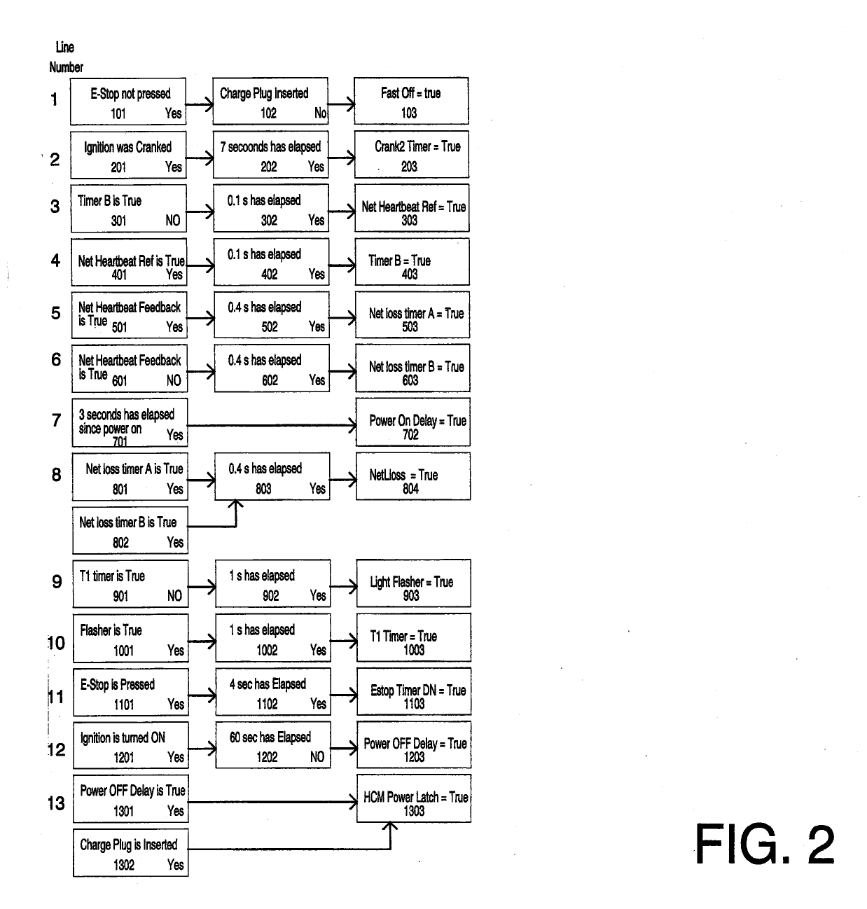

FIGS. 2-9 provide a logic diagram of the software that runs HCM 100. In the present embodiment, the software flow chart may be a functional diagram of the control logic for a hybrid electric terminal tractor. The ladder logic diagram in FIGS. 2-9 includes all of the control logic functionality for HCM 100, but it does not include details of analog I/O scaling, controller configuration, or mathematical calculations for standard curves. The ladder logic diagram is read left to right with the end block being the assignment or action block. If all the preceding conditions are met then the assignment block variable is true. If all the conditions are not met then the assignment block variable is false. HCM 100 evaluates one line at a time and when HCM 100 has completed all lines, HCM 100 starts over at the beginning. There are some assignment block variables that are used on other lines in the program as conditions for other functions. The logic diagram shown in FIGS. 2-9 is only intended as guide and many defined variables can be modified based on end user desired configuration and operation of vehicle 10.

As shown in FIG. 2, Line 1 performs a “Fast Off” function at 103. The “Fast Off” function at 103 may turn off the main direct current (DC) contactors in generator 22. The “E-stop” variable at 101 in Line 1 may disable all electrical power in vehicle 10. In the present embodiment, vehicle 10 has an e-stop button in the cabin for the operator and a second e-stop button on the outside of vehicle 10 (not shown). Charge plug at 102 is an external option on vehicle 10 and allows the operator to electrically charge one or more batteries on vehicle 10 by plugging vehicle 10 into a wall or charging station while parked. If the e-stop has not been pressed at 101, and the charge plug is not inserted at 102, then the “Fast Off” function is true at 103. HCM 100 may perform a fast off function at 103 if the e-stop button at 101 is pressed or if the charge plug at 102 is inserted. Once the value of “Fast Off” is true at 103, this variable is used elsewhere in the program to provide a shut-down to vehicle 10.

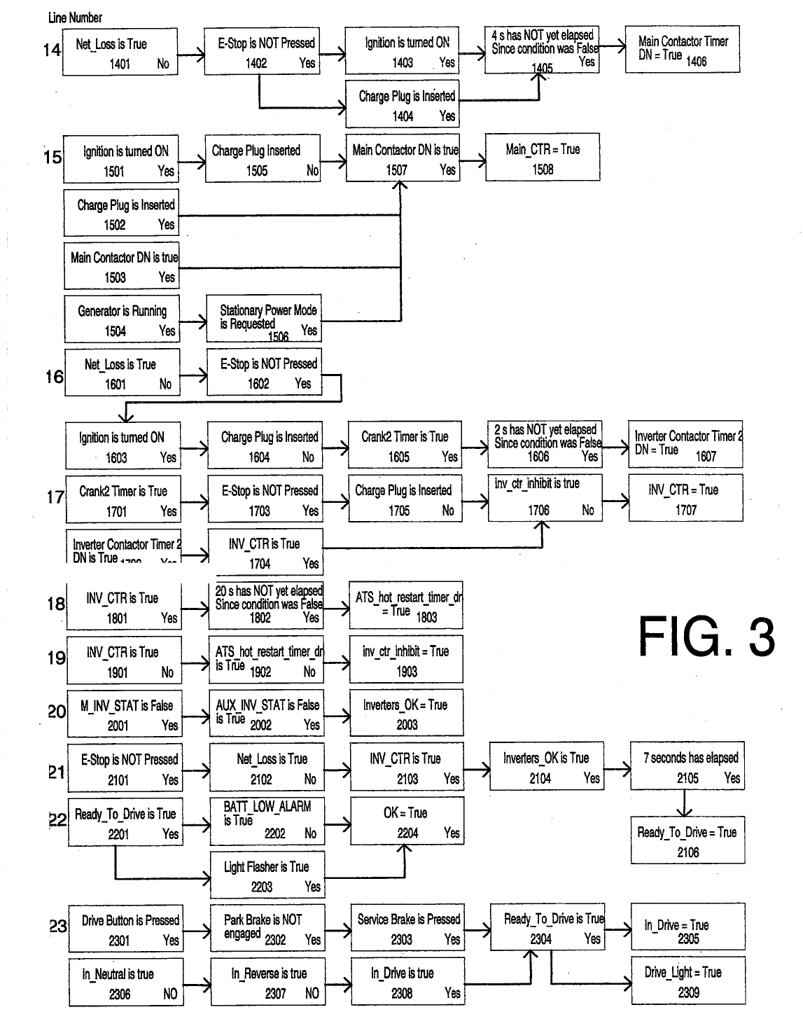

As shown in FIG. 2, Line 2 provides a time delay for turning on inverter DC contactors after the ignition is cranked. In the present embodiment, the time delay is seven seconds at 202, which is coordinated with other variables in HCM 100. The time delay at 202 in Line 2 can be varied based on various operating parameters and other vehicle configurations. If ignition is cranked at 201 and 7 seconds has elapsed at 202, then the value for Crank2 Timer is true at 203. Line 2 performs a time delay, which is used on Line 18 (see FIG. 3) to delay turning on the inverter DC contactors after the ignition key is cranked.

Lines 3 and 4 are used to set up a toggling bit at 0.1 seconds. This toggling bit is labeled “Net Heartbeat Ref” at 303. The time variable for the toggling bit at 302 or 402 can be varied, based on different configurations for hybrid vehicles 10. This toggling bit at 302 or 402 is sent to a networked controller 50 to determine communication loss between networked controller 50 and HCM 100. Networked controller 50 communicates with the HCM 100. In the present embodiment, networked controller 50 is located on vehicle 10. In the present embodiment, networked controller 50 sends and receives signals from the HCM 100 to determine communication loss. As shown in Line 3, when the value for of Timer B is false or not available at 301 and when 0.1 seconds have elapsed at 302, then value for “Net Heartbeat Ref” will be true at 303. As shown in Line 4, if the “Net Heartbeat Ref” is true at 401, and 0.1 seconds have elapsed, then Timer B is true at 403. The variables in Lines 3 and 4 are sent from the HCM 100 to 1000 networked controller 50 to determine if a communication loss is present in control system 1000. Lines 5 and 6 provide the logic to determine if there is feedback from networked controller 50. Lines 5 and 6 check that a “Net Heartbeat Feedback” at 501 and/or 601 bit is not true or not false for more than 0.4 seconds at 502 and/or 602. The “Net Heartbeat Feedback” bit is fed back or retransmitted from networked controller 50 to HCM 100. If the “Net Heartbeat Feedback” is stuck in either state (i.e., there is no response) then a communication loss must have occurred. As shown in Line 5, if “Net Heartbeat Feedback” variable is true at 501, and 0.4 seconds have elapsed at 502, then the “Net loss Timer A” variable is true at 503, which signals that a communication loss has occurred between HCM 100 and networked controller 50. As shown in Line 6, if “Net Heartbeat Feedback” variable at 603 is not true at 601 and 0.4 seconds have elapsed at 602 then the “Network loss Timer B” variable is true at 603, which signals that a communication loss has occurred between HCM 100 and networked controller 50. Lines 7 and 8 provide a delay in HCM 100 for a communication loss (network loss fault) between HCM 100 and networked controller 50. The delay provides enough time during controller power on and boot up so that both HCM 100 and networked controller 50 have enough time to be ready to establish communication. Line 7 provides a default delay after power on before the HCM 100 checks to see if the communication is ready between HCM 100 and networked controller 50. As provided in Line 7, the system has a default three second lapse at 701, which triggers the power on delay at 702, before checking to see if communication is established between HCM 100 and networked controller 50. As shown in Line 8, if the “Net loss timer A” variable is true at 801 or if the “Net loss timer B” variable is true at 802, and 0.4 seconds have elapsed at 803, then the “Net_Loss” variable is set to true at 804, which signifies that the networked controller 50 and HCM 100 have not lost established communication. Lines 9 and 10 are used to set up a toggling bit. In the present embodiment, the toggling bit is used to alert an operator of a fault by a flashing signal in the operator's field of view.

As shown in FIG. 2, Lines 11-13 provide a shut down sequence for vehicle 10. Line 11 performs a four (4) second delay when the e-stop button is pressed by operator, and this variable is used elsewhere in the HCM 100 for coordinating shutdown procedures. As shown in Line 11, if the e-stop button is pressed at 1101 and four (4) seconds have elapsed at 1102 then the value for the “Estop Timer DN” variable will be true at 1103. Line 12 performs a sixty (60) second delay after the operator turns the ignition off. This allows other portions of the code to perform a coordinated shutdown procedure, minimizing any potential harm to hardware in vehicle 10. As shown in Line 12 of FIG. 2, if the ignition is turned on at 1201 and sixty (60) seconds have not elapsed at 1202 (since the ignition has been turned off), the “Power OFF delay” variable is true at 1203, which may allow the operator of vehicle 10 to restart vehicle 10 after vehicle 10 has had a chance to properly shut down.

Also shown in FIG. 2, Line 13 allows the HCM 100 to hold or latch its own power on by using one of its outputs and a relay. After the operator turns off the ignition, HCM 100 holds its own power on to perform a coordinated shutdown. After the 60 second shutdown procedure is implemented the system shuts its own power off using Line 13. If the sequence in Line 13 is completed and the variable “HCM Power Latch” is false at 1303 then HCM 100 and hybrid vehicle 10 cannot restart again without human intervention (e.g., activating ignition switch). Line 13 is the final step in the shut down sequence

As shown in FIG. 3, Line 14 provides a four (4) second timer variable called “Main Contactor Timer DN” that initiates the coordinated shutdown. As shown in Line 14, if the network loss, “Net_Loss” variable, is not true at 1401 and the e-stop button is not pressed at 1402 and the ignition is turned on at 1403 and/or the charge plug is inserted at 1404 and the four (4) second (timer) has not yet elapsed since all preceding conditions were False (a time out function “TOF”) at 1405, then the value for the “Main Contract Timer DN” variable is true at 1406. For a TOF, if the input is true then the output is true or if the input goes false, then the output goes false after a predetermined time delay. The variable at 1405 is kept true for 4 seconds after the input conditions go false (i.e., the ignition is shut off), which can initiate a coordinated shutdown. If the “Main Contactor DN” variable is true at 1406, this is further used as a variable in Line 15.

Line 15 turns on the main DC contactors for vehicle 10. When the ignition is turned on at 1501 and the charge plug is not inserted at 1505 and the value for “Main Contactor DN” variable is true at 1507, then the main contactor “Main_CTR” variable is true at 1508, which allows the main DC contactors to be turned on. Line 15 also provides that if the charge plug is inserted at 1502 and if the timer variable “Main Contactor DN” is true at 1507, then the “Main Contactor” variable value is true at 1508, which allows the main DC contactors to be turned on. Line 15 also provides that if the timer “Main Contactor DN” variable is true at 1507, then the “Main_CTR” variable is true at 1508, which allows the main DC contactors to be turned on. Line 15 also provides that if the generator is running at 1504, and if stationary power mode is requested at 1506 and the timer “Main Contactor DN” variable is true at 1507, then the “Main_CTR” variable is true at 1508, which allows the main DC contactors to be turned on.

As shown in FIG. 3, Line 16 provides a time delay to coordinate turning the inverter contactor on and the inverter contactor off. As shown in Line 16, if there is no network loss at 1601 and the e-stop button is not pressed at 1602 and the ignition is turned on at 1603 and the charge plug is not inserted at 1604, and the “Crank 2 Timer” variable is true at 1605 and that two (2) seconds have not elapsed since all preceding functions are false (TOF) at 1606 then the variable “Inverter Contactor Timer 2 DN” is true at 1607. The variable “Inverter Contactor Timer 2 DN” at 1607 signifies that the timer is completed, and this variable is used in Line 17. Line 17 turns on the inverter DC contactors. The inverter DC contactors conduct power from the main contactors to the traction inverter and auxiliary inverter on vehicle 10 (see FIG. 10). As shown in Line 17, when the “Crank2 Timer” variable is true at 1701 and the e-stop button is not pressed at 1703 and charge plug is not inserted at 1705 and the variable “inv_ctr_inhibit” is not true at 1706, then the “INV_CRT” variable is true, which allows the inverter DC contactors to be turned on by HCM 100. Also shown in Line 17, when the variable “Inverter Contactor Timer 2 DN” is true at 1702 and the variable “_CTR” is true at 1704 and the variable “inv_ctr_inhibit” is true at 1706, then the variable “INV_CTR” is true at 1707, which allows the inverter DC contactors to be turned on by HCM 100. There are times when the main contactors are on but the inverter contactors are off. One such condition would be when vehicle 10 is parked and charging the batteries from grid power.

As shown in FIG. 3, Lines 18 and 19 set up a time delays that minimize the risk of the inverter contactor turning off and then back on before the inverters have had a chance to fully power off. Lines 18 and 19 cannot be overridden by the operator. Lines 18 and 19 allow an operator of vehicle 10 to wait a short amount of time before proceeding with trying to restart the vehicle 10. Line 18 provides that when the variable “INV_CTR” is true at 1801 and if twenty (20) seconds have not yet elapsed since preceding conditions are false (TOF) at 1802, then the “ATS_hot_restart_timer_dn” variable is true at 1803. As shown in Line 19, when the variable “INV_CTR” is not true at 1901 and the variable “ATS_hot_restart_timer_dn” is not true at 1902 then the variable “inv_ctr_inhibit” is true at 1903. When the variable “inv_ctr_inhibit” is true at 1903 then the HCM 100 permits an operator from turning on the inverter DC contactors.

Line 20 checks the status of the main and auxiliary inverters and checks for any faulted conditions. Line 20 provides that when the main inverter status “M_INV_STAT” variable is false at 2001 and when the auxiliary inverter status “AUX_INV_STAT” variable is false at 2002, then the variable “inverters_OK” is true at 2003. Line 21 checks for fault and status conditions in HCM 100 and turns on the variable “Ready_To_Drive” at 2106 when all conditions are met for vehicle 10 to be operated or driven. Line 21 provides that when the e-stop button is not pressed at 2101 and there is no loss of communication, the “Net_Loss” variable is not true at 2102, and when the variable “INV_CTR” is true at 2103 and after seven seconds has elapsed at 2105, then the “Ready_To_Drive” variable will be true at 2106. Line 22 uses the “Ready_To_Drive” input to signal the operator with a light labeled “OK”. When the batteries are low but everything else is functioning properly in the system, then the “OK” light flashes at 2204, to signal the low battery level to the operator.

It should be noted that for Lines 23-25, there are no physical drive, neutral and reverse gears in vehicle 10. Forward, reverse, and neutral “movements” of vehicle 10 are accomplished entirely electronically through electric motor 28 which drives motive unit 30. In the present embodiment, electric traction motor 28 is mechanically coupled to the driveshaft of motive unit 30, which causes vehicle 10 to move forward, move in reverse, or stay in “neutral.” Vehicle 10 does not have a transmission, like a conventional vehicle. The electric traction motor is commanded to run in reverse to operate vehicle 10 in reverse direction.

As shown in FIG. 3, Line 23 controls the “In_” variable. In Line 23 when the drive button is pressed at 2301, and the parking brake is not engaged at 2302, and the “In_Reverse” variable is not true at 2307, and the “In-Drive” variable is true at 2308, and the service brake is pressed (the brake pedal by accelerator) at 2303, and the “Ready_to_Drive” variable is true at 2304, then the “In_Drive” variable is true at 2305 and the “Drive_Light” variable is true at 2309. The “Drive_Light” variable at 2309 provides a signal to operator in the cabin of vehicle 10 that the vehicle is in drive. Line 23 also provides that “in Neutral” is not true at 2306, and “In_Reverse” is not true at 2307, and the “In_Drive” variable is true at 2308, and the “Ready_To_Drive” variable is true at 2304, then the “In_Drive” variable is true at 2305 and the “Drive_Light” variable is true at 2309.

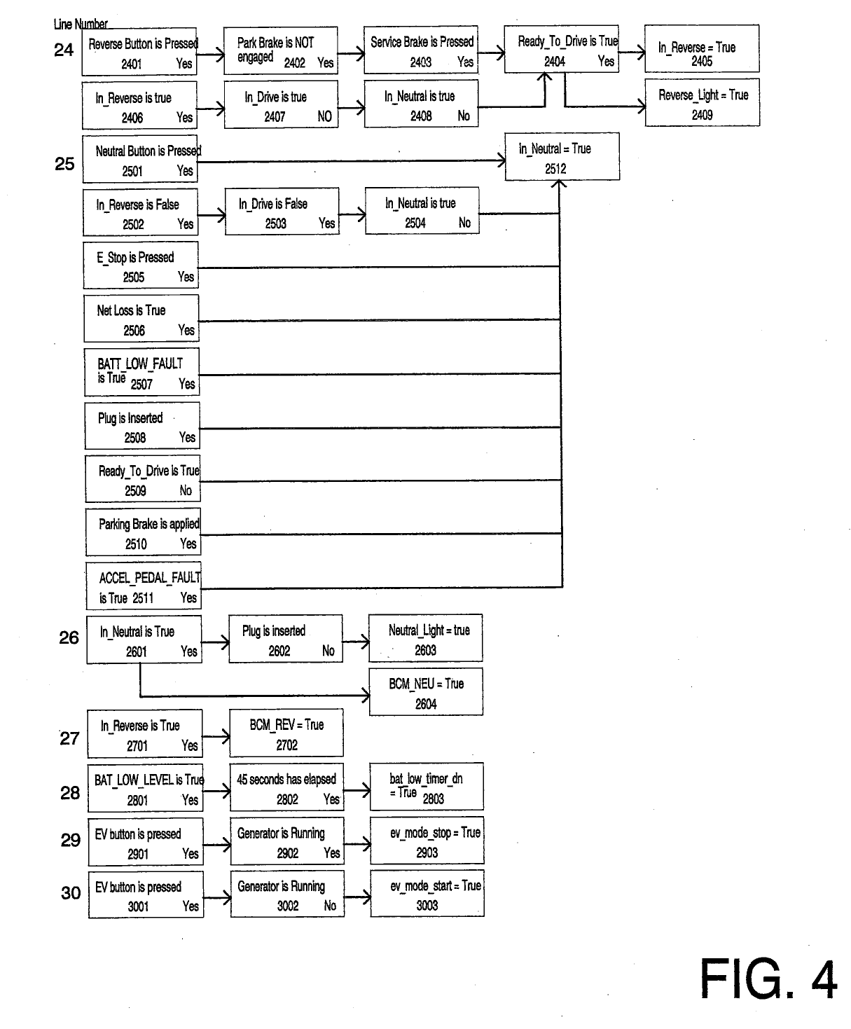

As shown in FIG. 4, Line 24 controls the “In_Reverse” variable. This variable is used to move the vehicle backward, or place vehicle 10 in reverse “gear,” like in a conventional vehicle. Line 24 provides that when the reverse button is pressed at 2401 and the parking brake is not engaged at 2402 and the service brake is pressed at 2403 and the “Ready_To_Drive” variable is true at 2404 then the “In_Reverse” variable is true at 2405 and the “Reverse_Light” variable is true at 2409, as shown to the operator in the cabin of vehicle 10. The “Reverse_Light” variable provides a signal to operator in the cabin of vehicle 10 that vehicle 10 is in reverse. Line 24 also provides that when the “In_Reverse” variable true at 2406 and the “In_Drive” variable is not true at 2407 and the variable “In_Neutral” is not true at 2408 and the “Ready_To_Drive” variable is true at 2404 then the “In_Reverse” variable is true at 2405 and the “Reverse_Light” variable is true at 2409.

Line 25 controls the “In_Neutral” variable. “In_Neutral” variable is used to keep vehicle 10, basically placing vehicle 10 in neutral “gear,” like in a conventional vehicle. Line 25 provides a number of scenarios when the “In_Neutral” variable will be true at 2512, and vehicle 10 will be in a neutral state. When the neutral button is pressed at 2501, the “In_Neutral” variable at 2512 is true. When the “In_Reverse” variable is false at 2502, and the “In_Drive” variable is false at 2503, and the “In_Neutral” variable is not true at 2504, then the “In_Neutral” variable at 2512 is true. When the e-stop button is pressed at 2505, then the “In_Neutral” variable at 2512 is true. When there is a network loss, HCM 100 may automatically take over and place vehicle 10 in neutral. This feature is shown in Line 25 when the “Net_Loss” variable is true at 2506, then the “In_Neutral” variable at 2512 is true. In addition, when the charge available in battery 24 becomes too low, then vehicle 10 may be automatically put into neutral to repower battery 24. When the variable “BATT_LOW_FAULT” is true at 2507, then the “In_Neutral” variable at 2512 is true, the drive shaft of vehicle 10 is shut off to repower battery 24 of vehicle 10. When a plug is inserted at 2508, then the “In_Neutral” variable at 2512 is true, which minimizes the risk of an operator driving away while vehicle 10 is plugged in for charging. When the “Ready_To_Drive” variable is not true at 2509, then the “In_Neutral” variable at 2512 is true. When the parking brake is applied at 2510, then the “In_Neutral” variable at 2512 is true, the risk of an operator driving vehicle 10 while parking brake is engaged is minimized. When the variable “ACCEL_PEDAL_FAULT” is true, then the “In_Neutral” variable at 2512 is true, this provides a safety override in the HCM that when the system senses a fault relating to accelerator pedal, vehicle 10 may be automatically put into a neutral state.

Line 26 turns on a light to signal the operator that neutral has been selected. It also signals the BCM (Body Control Module) that neutral has been selected. Line 26 provides that when the “In_Neutral” variable is true at 2601 and when the plug is not inserted at 2602 then the “Neutral_Light” variable is true at 2603. The neutral light is illuminated in cabin of vehicle 10 to signal the operator. Line 26 also provides that when the “In_Neutral” variable is true at 2601 then the “BCM_NEU” variable is true, which signals the BCM that neutral has been selected.

Line 27 signals the BCM that reverse direction is selected for vehicle 10. In line 27, when the “In_Reverse” variable is true at 2701 then the “BCM_REV” variable is true at 2702, which may cause a reverse light and beeping to happen on the outside (or body) of vehicle 10.

Line 28 provides a timer to filter out low battery transient calculations. In Line 28 when the “BAT_LOW_LEVEL” variable is true at 2801 and after 45 seconds has elapsed at 2802 then “bat_low_timer_dn” is true at 2803. The “bat_low_timer_dn” is a timer variable the filters out any short, intermittent and unnecessary low battery signals that do not correspond with an actual low battery signal (which should last more than 45 seconds). Actual low battery signals of at least 45 seconds signal HCM 100 to recharge battery 24.

Lines 29 and 30 provide functionality for an operator EV button. The EV button allows the operator to run vehicle 10 in an all electric vehicle (EV) mode. The operator can press the EV button to shut the diesel generator off and return to EV mode. If vehicle 10 is already running in EV mode, pressing the EV button again restarts generator 22. Line 29 provides that when the EV button is pressed at 2901 and generator 22 is running at 2902 then the “ev_mode_stop” variable is true at 2903, which takes vehicle 10 into EV mode, and stops generator 22. Line 30 provides that when the EV button is pressed at 3001 and when the generator is not running at 3003, then the “ev_mode_start” variable is true, which restarts generator 22. This feature is useful because the noisy diesel generator 22 can be turned off or shut down when an operator needs to stop the vehicle to talk to ground personnel or in other instances.

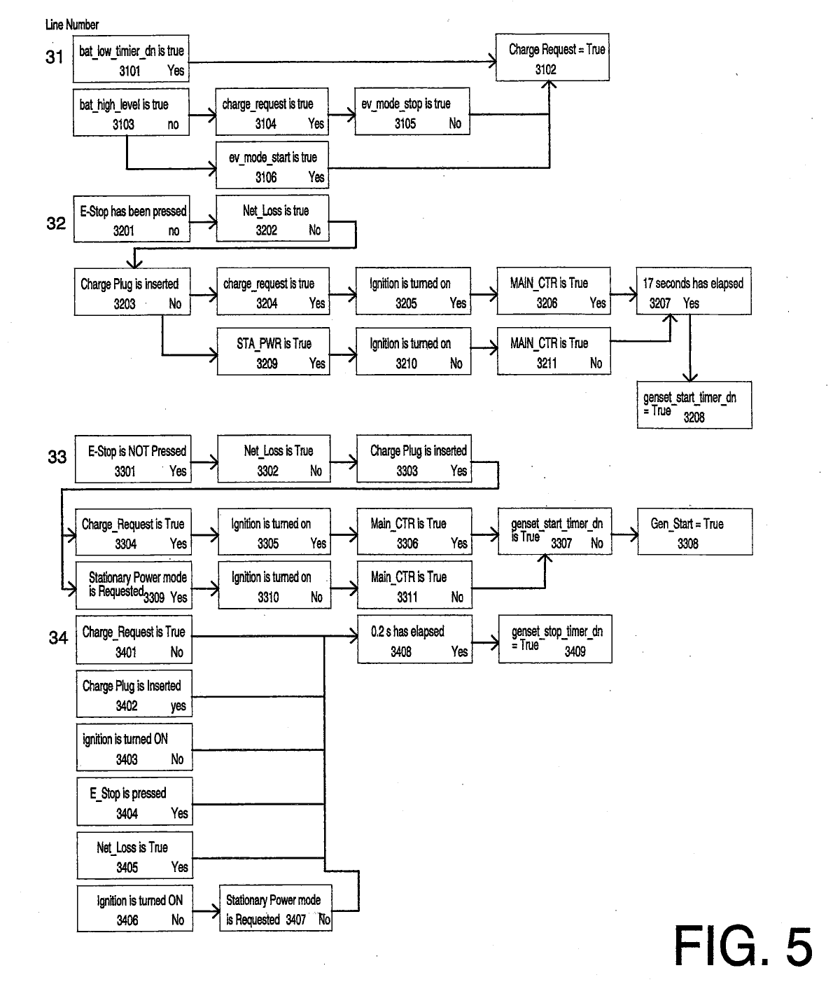

As shown in FIG. 5, Line 31 provides the conditions for when the diesel generator 22 starts up to charge battery 24 or batteries in vehicle 10. The HCM 100 may override some operator requests to ensure that battery 24 has a proper charge to power vehicle 10. When the battery state of charge is at a preset low state, the “Charge Request” variable is true. The “Charge request” variable remains true until the battery state of charge reaches a near full state or the operator presses the EV button. If the battery is low when the operator presses the EV button, HCM 100 may override the operator's command until the battery charge level reaches a predetermined value. Line 31 provides that when the “bat_low_timer_dn” variable is true at 3101 then charge request is true at 3102. Also at Line 31, if the “bat_high_level” variable is not true at 3103 and “charge_request” variable is true at 3104 and the “ev_mode_stop” variable is not true at 3105, then the charge request is true at 3102. When the “bat_high_level” variable is not true at 3103 and when the “ev_mode_start” variable is true at 3106, then charge request is true at 3102, this provides that while vehicle 10 is running in EV mode and the battery level is low a charge request variable will cause the diesel generator to start-up to charge the batteries, and may override an operator's command to run in EV mode.

As shown in FIG. 5, Lines 32 and 33 control the cranking of engine 20 to start generator 22. If all the input conditions are met, engine 20 will be cranked for up to 17 seconds. If engine 20 does not start, then a check engine light is illuminated in the cabin of vehicle 10 to signal operator. Line 32 provides that if the e-stop button has not been pressed at 3201 and the “Net_Loss” variable is not true (no loss in communication between HCM 100 and networked controller 50) at 3202 and charge plug has not been inserted at 3203 and the “charge_request” variable is true at 3204 and ignition is turned on at 3205 and the “MAIN_CTR” variable is true at 3206 and 17 seconds has elapsed at 3207, then the “genset_start_timer_dn” variable is true at 3208. The “genset_start_timer_dn” variable provides a signal to HCM 100 to stop cranking the diesel engine. Line 32 provides that if the e-stop button has not been pressed at 3201 and the “Net_Loss” variable is not true at 3202 and the charge plug has not been inserted at 3203 and the stationary power “STA_PWR” variable is true at 3209 and the ignition is not turned on at 3210 and the “MAIN_CTR” variable is not true at 3211 and 17 seconds has elapsed at 3207 then the “genset_start_time_dn” variable is true at 3208. This signifies the method in which HCM 100 starts generator 22 when in stationary power mode, for example, when vehicle 10 is operating the genset to supply a building with power during a power outage. Line 33 provides that if the e-stop button is not pressed at 3301 and the “Net_Loss” variable is not true at 3302 and the charge plug is inserted at 3303 and the “Charge_request” variable is true at 3304 and the ignition is turned on at 3305 and the “Main_CTR” variable is true at 3306 and the “genset_start_timer_dn” variable is false at 3307 (from Line 33), then the “Gen_Start” variable is true at 3308, which cranks engine 20 to turns generator 22 on. Line 33 also provides that if e-stop button not pressed at 3301 and the “Net_Loss” variable is not true at 3302 and the charge plug is inserted at 3303 and the stationary power mode is requested by operator at 3309 and the ignition is not turned on at 3310 and the “Main_CTR” variable is not true at 3311 and the “genset_start_timer_dn” variable is true at 3307, then the “Gen_Start” variable is true at 3308, which cranks engine 20 in vehicle 10.

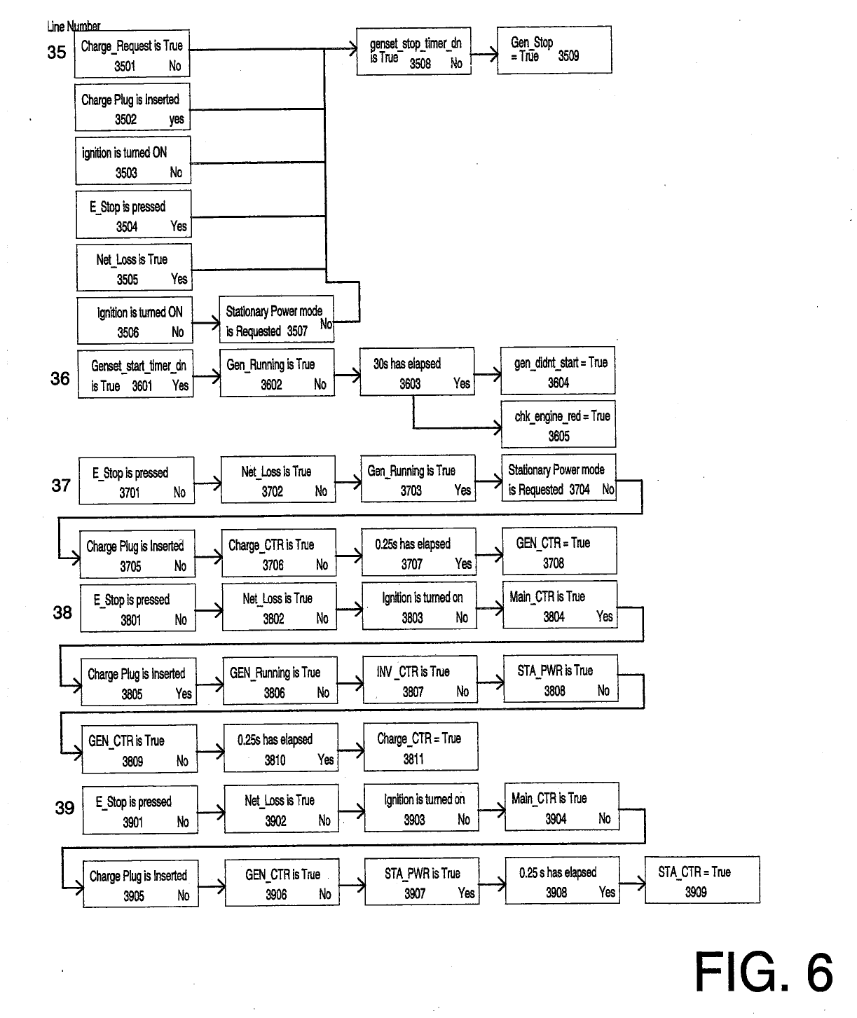

As shown in FIGS. 5 and 6, Lines 34 and 35 provide control of generator 22. In the present embodiment, the stop command may be asserted for 0.2 seconds. Line 34 provides a variety of scenarios that set the value of the “genset_stop_time_dn” variable to true, which stops the generator 22. Line 34 provides that if the “charge_request” variable is not true at 3401 and 0.2 seconds has elapsed at 3408 then the “genset_stop_dn” variable is true at 3409. Line 34 also provides that if charge plug is inserted at 3402 and 0.2 seconds have elapsed at 3408 then the “genset_stop_timer_dn” variable is true at 3409. Line 34 provides that if the ignition is not turned on at 3403 and 0.2 seconds have elapsed at 3408 then the “genset_stop_timer_dn” variable is true at 3409. Line 34 provides that if the e-stop button is pressed at 3304 and 0.2 seconds have elapsed at 3408 then the “genset_stop_timer_dn” variable is true at 3409. Line 34 also provides that if communication is lost between HCM 100 and networked controller 50 and the “Net_Loss” variable is true at 3405 and 0.2 seconds have elapsed at 3408 then the “genset_stop_timer_dn” variable is true at 3409. Finally, Line 34 provides that if ignition is not activated at 3406 and stationary power mode is not requested at 3407 and 0.2 seconds have elapsed at 3408 then the “genset_stop_timer_dn” variable is true at 3409. As shown in FIG. 6, Line 35 provides a generator 22 stop command at 3509. Line 35 provides the same set of scenarios as Line 34 but with the change that if the “genset_stop_timer_dn” variable is not yet true even though the scenarios are met, then the timer in 3408 must be counting down. While the timer at 3408 is counting down “genset_stop_timer_dn” is false and “Gen_Stop” is true, which stops the genset.

As shown in FIG. 6, Line 36 provides a method to determine if there are faults in generator 22 operation. For example, in the current embodiment, Line 36 checks to see if generator 22 failed to start or if generator 22 was running and stopped unexpectedly. If generator 22 is not running and it should be, the operator's Check Engine Light is turned on by HCM 100. Line 36 provides that if the “Genset_start_timer_dn” variable is true at 3601 and the “Gen_Running” variable is not true at 3602 and thirty (30) seconds have elapsed at 3603, then the “Gen_didnt_start” variable is true at 3603 and the “chk_engine_red” variable is true at 3064. The “chck_engine_red” variable provides a signal to the operator in the cabin of vehicle to check the engine.

Line 37 turns on the “GEN_CTR” generator contactors. In the present embodiment, these are AC contactors that take power from generator 22 and route it to the two onboard battery chargers. The onboard battery chargers are located on the onboard vehicle 10. Line 37 provides that when the e-stop button is not pressed at 3701 and the “Net_loss” variable (communication is still available between HCM 100 and networked controller 50) is not true at 3702 and thirty (30) seconds have elapsed at 3703 and the stationary power mode is not requested at 3704 and charge plug is not inserted at 3705 and the “Charge_CTR” variable is not true at 3706 and 0.25 seconds have elapsed at 3707, then the “GEN_CTR” variable is true at 3708, which turn on the generator contactors.

Line 38 turns on the “Charge_CTR” grid charge contactors. In the present embodiment, grid charge contactors are AC contactors that take power from the AC charge port and route it to one of the chargers. It is unlikely that both the generator contactors (controlled by Line 37) and charge contactors (controlled by Line 38) are on at the same time. Line 38 provides that when the e-stop button is not pressed at 3801 and the “Net_loss” variable is not true at 3802 and the ignition is not turned on at 3803 and the “Main_CTR” variable is true at 3804 and the charge plug is inserted at 3805 and the “GEN_Running” variable is false at 3806 and the “INV_CTR” inverter contactors variable is not true at 3809 and the stationary power “STA_PWR” variable is not true at 3808 and the “GEN_CTR” variable is false at 3809 and 0.25 seconds have elapsed at 3810, then the “Charge_CTR” variable is true at 3811.

As shown in FIG. 6, Line 39 activates the “STA_CTR” stationary contactors. In the present embodiment, the stationary contactors, are AC contactors take the AC power from the generator and route it to a power connector on the outside of vehicle 10. The power connector is used to supply power to external equipment on outside of vehicle 10. In this mode, vehicle can operate as a stationary Genset or a generator that can be moved from place to place. Line 39 provides that when the e-stop button is not pressed at 3901 and the “Net_Loss” variable is false at 3902 and the ignition is not turned on at 3903 and the “Main_CTR” variable is not true at 3904 and the charge plug is not inserted at 3905 and the “GEN_CTR” variable is not true at 3906 and the “STA_PWR” variable is true at 3907 and 0.25 seconds have elapsed at 3908 then the “STA_CTR” variable is true at 3909 and vehicle 10 may operate as a stationary Genset or generator.

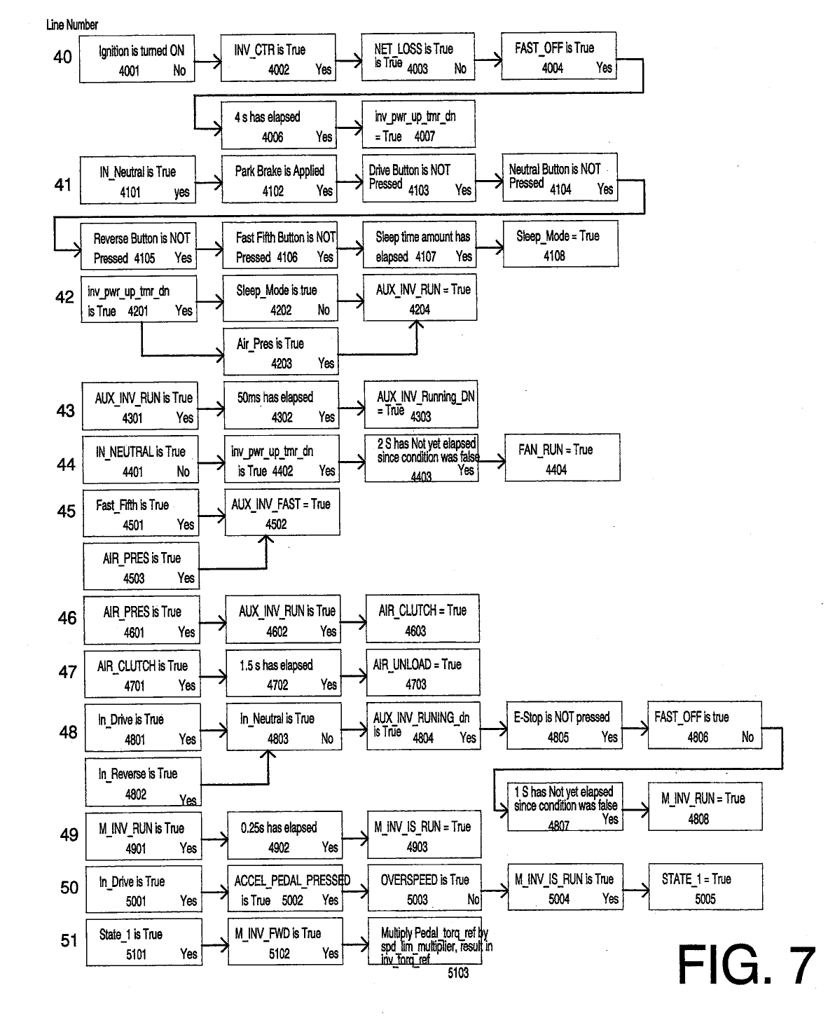

As shown in FIG. 7, Line 40 provides a delay between when the ac inverter contactors are turned on and when the ac inverters are commanded to run. This delay allows the ac inverters time to power on and boot up before receiving a run command. Line 40 provides that when ignition is not turned on at 4001 and when the inverted contactor “INV_CTR” variable is true at 4002 and the “Net_Loss” variable is not true at 4003 and the “FAST_OFF” variable is true at 4004 and four (4) seconds have elapsed at 4006, then the “inv_pwr_up_tmr_dn” variable, inverter power up timer, is true at 4007. The delay in starting up vehicle 10 provides the AC inverter time to power on and boot up before receiving a run command. The delay may be less than the time an operator would have to wait before driving a conventional diesel vehicle, which may require a long time delay to build air pressure for air brakes before operation.

Line 41 provides a “Sleep_Mode” function for when vehicle 10 is powered up but the operator is not or has not been actively driving the vehicle. Examples of when the “Sleep_Mode” function operates are, but not limited to, when vehicle 10 is in neutral, or when the parking brake is applied. After a predetermined sleep time has elapsed in this condition, a power save sleep mode is performed. The predetermined sleep time variable can be varied according to user specifications and can be modified at a later time. Line 41 provides that if the “IN_Neutral” variable (that the vehicle is in neutral) is true at 4101 and the parking brake is applied at 4102 and the drive button is not pressed at 4103 and the neutral button is not pressed at 4104 and the reverse button is not pressed at 4105 and the fast fifth button is not pressed at 4106 and the predetermined sleep timer amount has elapsed at 4007 then the “Sleep_Mode” variable is true and vehicle 10 is put into a “sleep” mode, until an operator takes some kind of action to take vehicle out of “sleep” mode.

Line 42 commands the auxiliary inverter to run. In the present embodiment, the auxiliary inverter provides hydraulic power steering, hydraulic 5^{th} wheel operation, and power to run the air compressor for the air brakes, the air horn, air ride seat, and external air tools. When in sleep mode, the auxiliary inverter is not run unless the truck is low on air, in which case the auxiliary inverter runs until air pressure has built up and then it goes back to sleep or stops. Line 42 provides that when the “inv_pwr_up_tmr_dn” variable is true at 4201 and the “Sleep_mode” variable is not true at 4202 or the “Air_Pres” variable is true 4203, then AUX_INV_RUN is true at 4204.

Line 43 provides a timer to indicate when the auxiliary inverter is commanded to run. Line 43 provides that if the “AUX_INV_RUN” variable is true at 4301 and 50 ms (milliseconds) have elapsed at 4302, then the “AUX_INV_Running_DN” variable is true at 4303, which commands the auxiliary inverter to run.

Line 44 controls the fan inverter. When vehicle 10 is not in neutral, (i.e., drive or reverse) the fan inverter is commanded to run. The fan inverter runs a fan motor that blows air across the main traction motor to cool it. In the present embodiment, the fan draws power from the main battery pack. Line 44 provides that if the “IN_Neutral” variable is not true at 4401 and the “inv_pwr_up_tmr” variable is true at 4402 and two (2) seconds have not yet elapsed since the preceding conditions were false (TOF), then the “FAN_RUN” variable is true at 4404 and the fan inverter is commanded to run. The fan inverter usually runs when needed to cool main traction motor.

As shown in FIG. 7, Line 45 controls the speed of the auxiliary motor. When the vehicle 10 is low on air the air compressor is started and the auxiliary inverter is ramped up to full speed to make air faster. If the operator presses the fast fifth button the auxiliary inverter is also ramped up to full speed. This may allow for a faster than usual operation of the hydraulic 5^{th} wheel. Line 45 provides that if the “Fast_fifth” variable is true in 4501 or if the “AIR_PRES” variable is true at 4502, then the “AUX_INV_FAST” variable is true at 4503, which ramps up the auxiliary inverter to a high speed to provide air for the fifth wheel or air compressor.

Line 46 activates the air clutch. The air clutch may be an electromechanical clutch on the auxiliary motor 44, and may be automatically controlled by HCM 100. When the clutch is engaged it provides mechanical power from auxiliary motor 44 to operate the air compressor 46. Line 46 provides that when the “AIR_PRES” variable is true at 4601 and the “AUX_INV_RUN” variable is true at 4602, then the “AIR_CLUTCH” variable is true at 4603, and the air clutch is activated to operate air compressor 46.

Line 47 controls the air compressor unloader. In the present embodiment, the unloader starts 1.5 seconds after the clutch is engaged and the air compressor 46 has begun to rotate and the compressor is loaded. This unloading delay may reduce wear on the clutch. The clutch engages into a rotating auxiliary motor but at a very reduced load because the compressor isn't loaded yet. Line 47 provides that if the “AIR_CLUTCH” variable is true at 4701 and if 1.5 seconds have elapsed at 4702 then the “AIR_UNLOAD” variable is true, and the unloader is engaged.

As shown in FIG. 7, Line 48 controls the “M_INV_RUN” variable command, main inverter run command. This is the command to the main traction inverter to run. The “M_INV_RUN” command is given in typical circumstances when drive or reverse is selected by the operator. The “M_INV_RUN” command is not given in typical circumstances when neutral is selected by operator. Line 48 provides that if the “IN_Drive” variable is true at 4801 or the “IN_Reverse” variable is true at 4802, and the “IN_Neutral” variable is not true at 4803 and the “AUX_INV_RUNNING_dn” variable is true at 4804 and the e-stop button is not pressed at 4805 and the “FAST_OFF” variable is not true at 4806 and one (1) second has not elapsed since the preceding conditions were false (TOF) at 4807, then the “M_INV_RUN” variable is true at 4808, which commands the main inverter to run.

Line 49 provides a timer indicating the command has been given to the main inverter to run. Line 49 provides that when the “M_INV_RUN” variable is true at 4901 and 0.25 seconds have elapsed at 4902 then the “M_INV_IS_RUN” variable is true at 4903.

Vehicle 10 of the present disclosure has a number of “running” states that are used to simulate normal conventional vehicle operation. The simulation of normal vehicle operation allows an operator of the present vehicle 10 to respond and drive as an operator originally learned to drive on a conventional vehicle. The simulation of normal vehicle operation minimizes training of operators on new driving techniques for vehicle 10. State 1 is the normal motoring (driving) torque, which operates like forward movement in a conventional vehicle. State 2 is transmission re-generation, which happens while vehicle 10 is in “drive,” and simulates an operator letting off the accelerator and a conventional vehicle naturally slowing down, also known as transmission drag. Generally, electric hybrid vehicles do not experience this “transmission drag;” however, HCM 100 provides this effect to vehicle to provide operator with the functionality to which the operator is accustomed. State 2 can be disabled in vehicle 10 if desired by end user, thereby eliminating the “transmission drag” effect, and minimizing energy usage during operation. State 2.5 is an overspeed minimization feature. The overspeed minimization feature minimizes the risk of vehicle 10 will exceed a maximum predefined speed. If an operator exceeds the maximum predefined speed of vehicle 10 the HCM 100 may engage a braking regenerative torque to slow hybrid vehicle, thereby keeping vehicle 10 below maximum speed. State 3 defines the regenerative braking feature of vehicle 10. When operator presses brake pedal, HCM 100 commands regenerative torque, which sends energy back into battery pack, which is done in conjunction with the conventional air brake system. In State 3, HCM 100 monitors air pressure in brake. In the present embodiment, the brake system of vehicle 10 provides smoother braking and saves on brake pads, because the first ten percent of the requested braking is regenerative and doesn't even use the air brake system. State 6 provides a “creep” function, and provides that when an operator has vehicle 10 in drive and the operator lets off the brake pedal vehicle 10 will slowly “creep” forward. State 6 may simulate the unintended mechanical “creep” function of conventional vehicles. In one embodiment, State 6 can be disabled to prevent “creep.” State 7 provides reverse motoring torque, which propels vehicle 10 in the reverse direction when operator applies pressure to accelerator and vehicle is in reverse. State 8 provides transmission drag for the reverse direction, as described above in State 2, except in the reverse direction. State 9 provides reverse creep, as described above in State 6, except in the reverse direction. In one embodiment, State 9 may be disabled by end users. State 10 provides the neutral or “do nothing” state for vehicle 10. In the present embodiment, if an operator wants to “park” the vehicle, the operator would apply parking brake. HCM 100 minimizes the risk that vehicle 10 will move in a forward or reverse direction, if parking brake of vehicle 10 is applied or activated.

As shown in FIG. 7, Line 50 provides the pseudo state machine control for State 1 when drive is selected and the accelerator pedal is being pressed. State 1 provides vehicle motoring torque. In Line 50, if the “In_Drive” variable is true at 5001 and the variable “ACCEL_PEDAL_IS_PRESSED” is true at 5002 and the “OVERSPEED” variable is not triggered at 5003 and the “M_INV_IS_RUN” variable (the main inverter is running), then State 1 is true at 5005. When State 1 is true, vehicle 10 is in drive and moving forward based on the pressure applied by operator to accelerator pedal. In Line 51, if State 1 is true then the accelerator pedal reference is multiplied by a speed limit multiplier before the result is entered into the main inverter torque reference to drive vehicle 10 forward. Line 51 provides that if State_{—}1 is true at 5101 and the varaiable “M_INV_FWD” (main inverter is moving traction motor in forward direction) is true at 5102, then the “Multiply Pedal_torq_ref by spd_lim_multipler, which results in inv_torq_ref” variable is performed at 5103.

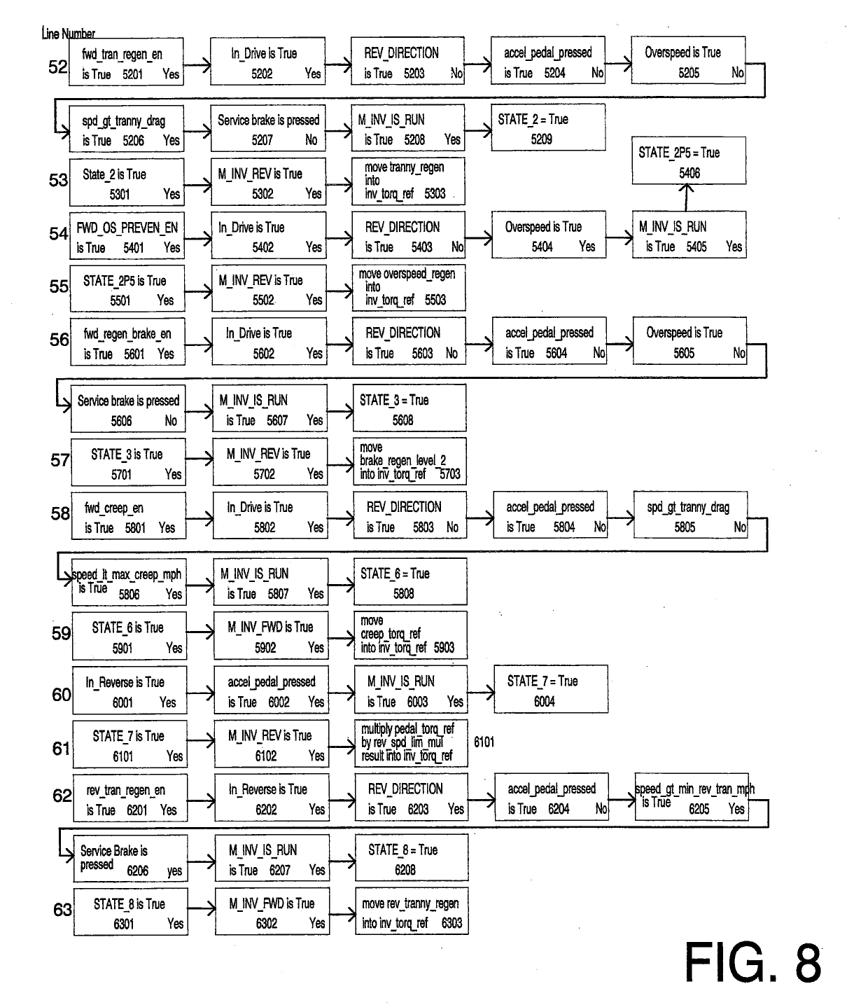

As shown in FIG. 8, Line 52 provides the pseudo state machine control for State 2 in when drive is selected but the operator is not pressing on the accelerator pedal. In State 2, transmission regeneration is done. What is being called transmission regeneration is not actually regeneration being done by a transmission because vehicle 10 does not have a transmission. Instead, State 2 “simulates” the effect of a conventional transmission when the accelerator pedal is released in vehicle 10. In a non-hybrid conventional vehicle, the transmission has some inherent drag and tends to slow the vehicle down, when the accelerator pedal is released. In vehicle 10, without simulating this same symptom, vehicle 10 would coast effortlessly when the operator lets off the accelerator. In the present embodiment, HCM 100 provides the “simulated” transmission regeneration, to minimize coasting that may be undesirable to some operators and may feel quite different compared to driving a conventional vehicle. In another embodiment, State 2 can be disabled, and vehicle 10 can be allowed to coast, thereby increasing vehicle 10 efficiency. Therefore, State 2 can be enabled or disabled in vehicle 10 of the present disclosure. Line 52 provides that when the “fwd_tran_regen_en” variable, forward transmission regeneration engaged, is true at 5201 and vehicle 10 is in drive at 5202 and vehicle 10 is not in reverse at 5203 and the accelerator pedal is not pressed at 5204 and the overspeed function (operator is not exceeding maximum vehicle speed) is not true at 5205 and the “spd_gt_tranny_drag” variable, speed greater than transmission drag, is true at 5206 and the service brake or brake pedal is not pressed at 5207 and the “M_INV_IS_RUN” variable, main inverter is running, is true at 5208, then State 2 is true and vehicle 10 operates in State 2.

As shown in FIG. 8, at Line 53 if state 2 is true at 5301 and the “M_INV_REV” variable, main inverter in reverse, is true at 5302, then “tranny_regen” torque level is moved into the inverter torque reference.

Line 54 provides the pseudo state machine control for State 2.5, when drive is selected and the vehicle speed has exceed the maximum allowed speed. State 2.5 provides an overspeed minimization function. In State 2.5, HCM 100 may prevent operator from exceeding the maximum allowable speed in vehicle 10. At Line 54 if the “FWD_OS_PREVEN_EN” variable, forward overspeed minimization is enabled, is true at 5401 and the “In drive” variable is true at 5402 and the vehicle is not in reverse at 5403, and the overspeed variable is true at 5404, and the “M_INV_IS_RUN” variable, main inverter is running, is true at 5405, then State 2.5 is true at 5206, which triggers the overspeed minimization function.

In Line 55, if state 2.5 is true then “overspeed_regen” torque level is moved into the inverter torque reference. In State 2.5 regenerative torque may be used to slow vehicle 10. HCM 100 may override the operator input of pushing on accelerator and may provide “braking” through the main inverter. HCM 100 may automatically perform line 55 and put vehicle 10 in State 2.5 if the maximum defined speed has been reached by operator. Line 55 provides that if the variable “State_{—}2.5” is true at 5501 and the “M_INV_REV” variable, main inverter in reverse (to “regeneratively” slow vehicle), is true at 5502, then the “move overspeed_regen into inv_torq_ref” is true at 5503.

Line 56 is the control for the pseudo state machine control for state 3. State 3 provides “regenerative braking”, i.e., when the operator is pressing on the brake pedal but is not pressing on the accelerator. State 3 performs regenerative braking Line 56 provides that when the variable “fwd_regen_brake_en,” forward regenerative braking is enabled, is true at 5601 and the vehicle is in drive at 5602 and vehicle is not in reverse at 5603 and the accelerator pedal is not pressed at 5604 and the overspeed function is not enabled at 5605 and the service brake (brake pedal) is pressed by operator at 5606 and the “M_INV_IS_RUN” variable is true at 5607, then State 3 is true at 5608. In Line 57, if State 3 (from Line 56) is true then “brake_regen_level_{—}2” torque level is moved into the inverter torque reference. The “brake_regen_level_{—}2” variable is calculated based on several factors including vehicle speed and how hard the operator is pressing on the brake.

Line 58 provides the pseudo state machine control for State 6. State 6 provides a “creep” function to emulate a conventional vehicle. In a conventional vehicle with a transmission, when the operator releases the brake, but without depressing the accelerator, from a standstill, the transmission may apply some torque to the wheels. This is an effect of the torque converted in the transmission. As the vehicle speed starts to increase the amount of torque decreases. Vehicle 10 does not have a transmission or torque converter and would not typically experience such movement. However, because automatic transmission vehicles ordinarily behave in this way, operators expect vehicle 10 to as well. To accomplish this, vehicle 10 simulates this small amount of torque electronically. In an alternative embodiment, State 6 can be disabled in the system, thereby eliminating the wasted energy and creep function in operating vehicle 10. In Line 58, when the “fwd_creep_en” variable, forward creep enabled, is true at 5801, and the vehicle is in drive at 5802, and vehicle is not in reverse at 5803, and the accelerator pedal is not being pressed by operator at 5804, and “speed_gt_tranny_drag” variable, the speed greater than transmission drag, is not true at 5805 and “speed_lt_Max creep_mph” variable, the speed is less than maximum speed for which creep is simulated, is true at 5806 and the “M_INV_REV” variable, main inverter in reverse, is true at 5807, then State 6 is true. In Line 59, if State 6 is true at 5901 then “creep_torque_ref” level is moved into “inv_torq_ref.” Note that “creep_torque_ref” is a calculated value based on vehicle speed. The “creep_torque_ref” value starts at a high level at standstill and reduces to zero at some higher speed.

Line 60 is provides the pseudo state machine control for State 7 when reverse is selected and the accelerator pedal is being pressed. State 7 provides reverse motoring torque. Line 60 provides that when the vehicle is in reverse at 6001 and the accelerator pedal is pressed by operator at 6002 and when the main inverter is running, “M_INV_IS_RUN” variable is true at 6003, then State 7 is true at 6004. In Line 61, if State 7 is true at 6101 then “pedal_torq_ref” is multiplied by “rev_spd_lim_mul” and the result is placed into “inv_torq_ref”. This allows for speed limiting in the reverse direction. The value in “rev_spd_lim_mul” is calculated and changes based on vehicle speed. At maximum reverse speed the “rev_spd_lim_mul” variable value is zero, thus limiting reverse speed. The reverse overspeed limiting feature in line 61 can be disabled.

Line 62 provides the pseudo state machine control for State 8 when reverse is selected and the accelerator pedal is not being pressed. State 8 provides transmission regeneration or drag, which is the same as State 2, but in the reverse direction. In one embodiment, State 8, the reverse drag function, in Lines 62 and 63 can be disabled. As shown in FIG. 8, Line 62 provides that when the “rev_tran_regen_en” variable, reverse transmission regeneration enabled, is true at 6201 and the vehicle is in reverse at 6202, the vehicle is moving in reverse at 6203, and the accelerator pedal is not pressed at 6204, and the variable “speed_gt_min_rev_tran_mph” is true at 6205 and service brake (brake pedal) is pressed by operator at 6506 and the “M_INV_IS_RUN” variable, main inverter is running, at 6506, then State 8 is true. In Line 63, if state 8 is true at 6301 and the “M_INV_FWD” variable, main inverter is running forward, at 6302, then “rev_tranny_regen” is moved into “inv_torq_ref,” which provides a conventional-type reverse drag for operator of hybrid vehicle.

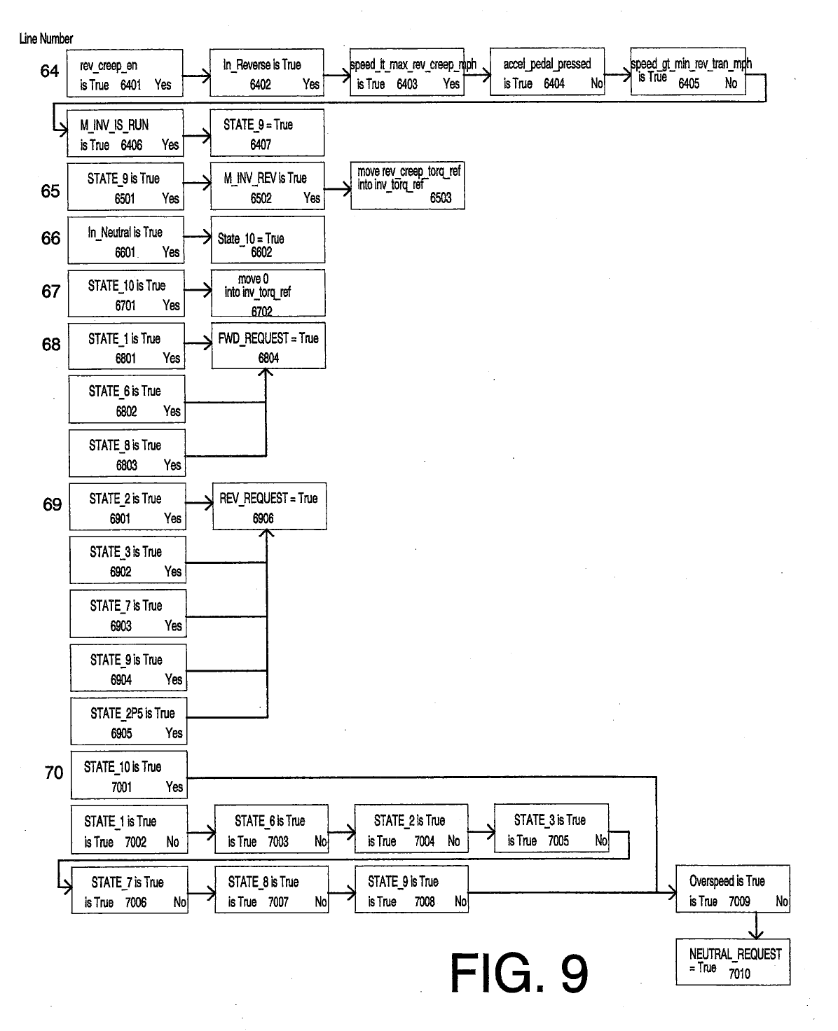

As shown in FIG. 9, Line 64 provides the pseudo state machine control for State 9 when reverse “creep” is performed. The reverse creep function in State 9 is similar to the forward creep function in State 6 but in the reverse direction. In Line 64, when the variable “rev_creep_en,” reverse creep enabled, is true at 6401 and the vehicle is in reverse at 6402, and the “speed_lt_max_rev_creep_mph” variable, the maximum speed creep is simulated for, is true at 6403 and the accelerator pedal is not pressed at 6404 and “speed_gt_min_rev_tran_mph” variable is not true at 6405 and the variable “M_INV_IS_RUN,” main inverter is running, is true at 6406, then State 9 is true, and reverse “creep” is performed by vehicle 10. In Line 65, if State 9 is true at 6501 and the variable “M_INV_REV,” main inverter in reverse, is true at 6502, then “rev_creep_torq_ref” is moved into “inv_torq_re” to make hybrid vehicle “creep” in reverse. State 9 can be enabled or disabled in vehicle 10, depending on end-user desired specifications for operation.

As shown in FIG. 9, Line 66 provides the pseudo state machine control for State 10 when vehicle 10 is in the neutral state. In Line 66, when vehicle 10 is in neutral at 6601, then State 10 is true. In Line 67, if State 10 is true at 6701, then a value of zero is moved into “inv_torq_ref,” which minimizes the risk of the inverter providing torque to move vehicle 10 in a forward or reverse direction.

As shown in FIG. 9, Line 68 combines the states and determines the main traction inverter's direction based on the state the vehicle is in. In this rung, if states 1, 6 or 8 are true then a forward command is given to the inverter via “FWD_REQUEST”. As shown in Line 68, if State 1 is true at 6801 or State 6 is true at 6802 or State 8 is true at 6803 then the “FWD_REQUEST” variable is true at 6804, which provide a forward command to main traction inverter.

As shown in FIG. 9, Line 69 combines the states and determines the main traction inverter's direction based on the state vehicle 10 is in. In Line 69 if states 2, 2.5, 3, 7, or 9 are true then a reverse command is given to the inverter via “REV_REQUEST”. As shown in Line 69, if State 2 is true at 6901 or if State 3 is true at 6902 or if State 7 is true at 6903 or State 9 is true at 6904 or State 2.5 is true at 6905, then the “REV_REQUEST” variable is true at 6906, which provides a reverse command to the main traction inverter.

Line 70 combines the states for neutral and also verifies that if no other state is selected or true then vehicle 10 is placed into a neutral state. Vehicle 10 is place into neutral state by a “NEUTRAL_REQUEST” variable. Line 70 provides that if State 10 is true at 7001 or State 1 is not true at 7002 or State 6 is not true at 7002 or State 2 is not true at 7003 or State is not true at 7005 or State 7 is not true at 7006 or State 8 is not true at 7007 or State 9 is not true at 7008, and that if the overspeed function is not true at 7009, then the variable “NEUTRAL_REQUEST” is true, and the vehicle is placed into a neutral state.

An example of an embodiment of the present disclosure is a Pluggable Hybrid Electric Terminal Tractor (PHETT). The PHETT uses the HCM 100 described in the preceding paragraphs to provide a series hybrid diesel truck that operates like a conventional terminal truck, but provides better carrying capacity and torque and a reduction in fuel consumption during operation. The PHETT is a single rear axle truck measuring 99 inches wide and 211 inches long. It has a carrying capacity of 130,000 lbs. GCW. The PHETT is a series diesel electric hybrid. The main electric traction motor in the PHETT is rated at 225 hp and has an auxiliary electric motor for all other auxiliary systems that is rated at 20 hp. PHETT using HCM 100, as described above, achieves up to 60% reduction in fuel consumption and zero exhaust and noise emissions in battery electric mode. It has a 30% reduction in decibels even when the diesel genset is running compared to a conventional truck. In battery electric mode, the PHETT is nearly silent. In battery electric mode, when the truck is driving towards you, the loudest audible thing is the tires on the gravel road. The PHETT has the ability to charge the battery pack using a built in onboard grid battery charger. This allows the truck to use significantly less expensive grid electricity to charge the batteries when parked, as compared to more expensive fuel sources such as, but not limited to, diesel, gas, hydrogen, or other fuel sources. The PHETT is “pluggable” because the PHETT can be charged by the grid when the vehicle is plugged in to the proper outlet.

While only certain features and embodiments of the disclosure have been shown and described, many modifications and changes may occur to those skilled in the art (for example, variations in sizes, dimensions, structures, shapes and proportions of the various elements, values of parameters (for example, temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. Furthermore, in an effort to provide a concise description of the exemplary embodiments, all features of an actual implementation may not have been described (i.e., those unrelated to the presently contemplated best mode of carrying out the disclosure, or those unrelated to enabling the claimed disclosure). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

What is claimed is:

1. A system for controlling a hybrid vehicle comprising:
a. a hybrid vehicle; and
b. a hybrid control module electronically connected to and controlling the hybrid vehicle, the hybrid control module comprising:
i. a computer, wherein the computer receives and processes signals from the hybrid control module;
ii. a plurality of predefined values and steps stored and implemented by the computer in response to a signal from the hybrid control module or an input from an operator, wherein each of the plurality of predefined values and steps controls a component of the hybrid vehicle or wherein each of the plurality of predefined values and steps controls a plurality of functions within the hybrid control module; and
wherein the hybrid control module provides a conventional vehicle functionality to the hybrid vehicle in response to the operator input.

2. The system of claim 1, wherein the hybrid vehicle is a series hybrid vehicle comprising:
a. an engine;
b. a generator mechanically connected to the engine;
c. a battery electrically connected to and powered by the generator;
d. an auxiliary power system electrically connected to the battery;
e. an electric fraction drive electrically connected to and powered by the battery;
f. an electric motor electrically connected to the electric traction drive; and
g. a motive power unit mechanically connected to the electric fraction drive.

3. The system of claim 1, wherein the plurality of functions include: a power sleep mode, an operator override mode, a battery charge mode, a stationary genset mode, a torque control mode, an auxiliary motor control mode, and a reduced noise mode.

4. The system of claim 1, wherein the conventional vehicle functionality includes a plurality of operation states including a creep mode, a simulated transmission regeneration mode, and a maximum overspeed mode.

5. The system of claim 5, wherein the creep mode is implemented in forward or reverse movement of the hybrid vehicle.

6. The system of claim 5, wherein the simulated transmission regeneration mode is implemented in forward movement of the hybrid vehicle.

7. The system of claim 5, wherein the maximum overspeed mode is implemented in forward movement of the hybrid vehicle.

8. The system of claim 1, wherein the predefined values and steps stored and implemented by the computer are editable.

9. A hybrid control module, wherein the hybrid control module further comprises:
a. a computer, wherein the computer receives and processes signals from the hybrid control module; and
b. a plurality of predefined values and steps stored and implemented by the computer in response to the signals from the hybrid control module and input from an operator, wherein each of the plurality of predefined values and steps controls a component of a hybrid vehicle or wherein each of the plurality of predefined values and steps controls a plurality of functions within the hybrid control module; and
wherein the hybrid control module provides a conventional vehicle functionality to the hybrid vehicle in response to the operator input.

10. The hybrid control module of claim 9, wherein the plurality of functions include: a power sleep mode, an operator override mode, a battery charge mode, a stationary genset mode, a torque control mode, an auxiliary motor control mode, and a reduced noise mode.

11. The hybrid control module of claim 9, wherein the conventional vehicle functionality includes a plurality of operation states including a creep mode, a simulated transmission regeneration mode, and a maximum overspeed mode.

12. The hybrid control module of claim 11, wherein the creep mode is implemented in forward or reverse movement of the hybrid vehicle.

13. The hybrid control module of claim 11, wherein the simulated transmission regeneration mode is implemented in forward movement of the hybrid vehicle.

14. The hybrid control module of claim 11, wherein the maximum overspeed mode is implemented in forward movement of the hybrid vehicle.

15. The hybrid control module of claim 1, wherein the predefined values and steps stored and implemented by the computer are editable.

16. A method for controlling a hybrid vehicle comprising the steps of:
a. providing a hybrid control module;
b. obtaining operator input;
c. providing the operator input to the hybrid control module;
d. executing a plurality of steps as a result of the operator input; and
e. controlling the hybrid vehicle as desired by the operator.

17. The method of claim 16, wherein the hybrid control module comprises:
a. a computer, wherein the computer receives and processes signals from the hybrid control module; and
b. a plurality of predefined values and steps stored and implemented by the computer in response to the signals from the hybrid control module and input from an operator, wherein each of the plurality of predefined values and steps controls a component of the hybrid vehicle or wherein each of the plurality of predefined values and steps controls a plurality of functions within the hybrid control module; and
wherein the hybrid control module provides a conventional vehicle functionality and feel to the hybrid vehicle in response to the operator input.

18. The method of claim 16, wherein hybrid control module overrides operator input to charge a battery.

19. The method of claim 16, wherein the plurality of functions include: a power sleep mode, an operator override mode, a battery charge mode, a stationary genset mode, a torque control mode, an auxiliary motor control mode, and a reduced noise mode.

20. The method of claim 17, wherein the conventional vehicle functionality and feel include a plurality of operation states including a creep mode, a simulated transmission regeneration mode, and a maximum overspeed mode.
